(19) United States
(12) Patent Application Publication
(10) Pub. No.: US 2005/0044908 A1
(43) Pub. Date: Mar. 3, 2005

(54) Digital door lock capable of detecting its operation states

(76) Inventor: Byong Do Min, Incheon (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(21) Appl. No.: 10/495,573

(22) PCT Filed: Nov. 8, 2002
(86) PCT No.: PCT/KR02/02081

(30) Foreign Application Priority Data
Nov. 15, 2001 (KR) 2001-71148
Nov. 15, 2001 (KR) 2001-71149

(51) Int. Cl. E05B 47/00; E05B 41/00

(52) U.S. Cl. 70/276; 70/432

(57) ABSTRACT

The present invention relates to a digital door lock that is capable of detecting the rotations of a central gear and rotator in a non-contact sensing manner so as to accurately sense the locations where the central gear and rotator just rotate, and automatically sensing the opened/closed state of a door to check the operation state of the door lock itself by mounting a receiving sensor on a dead bolt assembly constituting an electromagnetic door lock device and a transmitting sensor on a strike box also constituting the electromagnetic door lock device, thereby lengthening a life span of the door lock.

### TECHNICAL FIELD

The present invention relates to a digital door lock, and more particularly, to a digital door lock that is capable of detecting the rotations of a central gear and a rotator in a non-contact sensing manner so as to accurately sense the locations where the central gear and rotator just rotate, and automatically sensing the opened/closed state of a door to check the operation state of the door lock itself by mounting a receiving sensor on a dead bolt assembly constituting an electromagnetic door lock device and a transmitting sensor on a strike box also constituting the electromagnetic door lock device.

### BACKGROUND ART

An electromagnetic door lock refers to a device that is used to keep a door in an opened/closed state by depressing a combination of prescribed numeric keys on a keypad arranged in the form of a matrix, without using a separate key. Demands for the device have been increasing day by day because of its convenience and reliability in use.

Such an electromagnetic door lock generally includes an outside body that is located on the outside of a door, an inside body that is located on the inside of the door, and a dead bolt assembly for locking and unlocking the door, which is located between the inside body and the outside body.

The inside body has an operation lever that is coupled to the dead volt assembly at one end thereof. The dead bolt assembly locks or unlocks the door by the operation of the lever.

Meanwhile, the outside body has a keypad and a key cylinder that is coupled to the dead bolt assembly at one end thereof. The dead bolt assembly locks and unlocks the door by the operation of the key cylinder.

A control unit receives an input signal of the combination of the numeric keys from the keypad, such that it drives a motor installed in the inside body to lock and unlock the door. That is, when the motor is driven, the central gear fitted between the operation lever and the dead bolt assembly rotates and at the same time, the dead bolt assembly works, such that the door is locked or unlocked. Here, the control unit checks whether a rotator that operates by the engagement with the operation lever rotates or not and with the checking result, determines a rotation degree of the central gear.

Recently, there have been developed another electromagnetic door lock that can automatically lock the door when the door is closed, even though a user does not carry out operations for locking the door using a key.

The above-mentioned electromagnetic door lock includes: a guide latch that is supported elastically to be protruded and is pushed to go as it abuts against the guide surface of a locking protrusion that is fixedly secured to a doorframe; a locking latch that is supported elastically in its usually protruded direction, such that when the door starts to be closed, it is pushed to go as it abuts against the edge portion of the locking protrusion and thus it is inserted into a locking hole when the door is completely closed; a door opening/closing sensor that mechanically sense the operations of the latches; and a control unit that drives a motor in response to a signal outputted from the door opening/closing sensor.

In the operation of the electromagnetic door lock, when the door is closed, the guide latch starts to be pushed to go as it abuts against the guide surface of the locking protrusion, and the locking latch starts to be pushed to go as it abuts against the edge portion of the locking protrusion and is thus protruded by virtue of the elasticity of a spring, such that it is caught by the locking hole. At the same time, the door opening/closing sensor senses the closed state of the door and outputs a sensing signal to the control part. Thereby, the control unit drives the motor to automatically lock the door.

In order to unlock a locked door, the input of a combination of the numeric keys on the keypad, the depression of a button for releasing the locked state, or the manipulation of a key should be followed. In other words, when such actions are taken, the locking latch is escaped from the locking hole of the locking protrusion to release the locked state of the door.

Therefore, the electromagnetic door lock enables the door to be automatically locked even when the user doesn't lock the door.

However, for the electromagnetic door lock as aforementioned, there have been problems in that the door opening/closing sensor is in the direct contact with the doorframe, so its protruded portion may be easily broken and thus, it can fail to accurately sense the open/closed state of the door; which prevents the door from being automatically locked.

Moreover, the electromagnetic door lock has additional problems in that the door opening/closing sensor checks in the mechanical fashion whether a central gear and a rotator rotate or not, such that there occur some problems that the sensor does not abut fully against the central gear and rotator or may be broken partially, which causes it not to operate appropriately. As a result, a life span of the electromagnetic door lock is shortened.

### DISCLOSURE OF INVENTION

Therefore, the present invention has been made in view of the above problems, and it is an object of the present invention to provide a digital door lock that detects the rotations of a central gear and a rotator in a non-contact sensing manner, thereby enabling the operation state of the door lock itself to be sensed.

It is another object of the present invention to provide a digital door lock that senses the open/closed state of a door in a non-contact sensing manner to automatically lock the door, thereby enabling the operation state of the door lock itself to be sensed.

In order to achieve the above objects, according to one aspect of the present invention, there is provided a digital door lock that includes: a rotator dog opened state-checking non-contact sensing switch adapted to check whether a dog of a rotator is in an opened state; a rotator dog closed state-checking non-contact-sensing switch adapted to check whether a dog of a rotator is in a closed state; a central gear dog neutral state-checking non-contact sensing switch adapted to check whether a dog of a central gear is in a neutral state; and a printed circuit board (PCB) assembly having said rotator dog opened state checking non-contact sensing switch, said rotator dog closed state checking non-contact sensing switch and said central gear dog neutral state checking non-contact sensing switch mounted on the front thereof, and adapted to output the location signals of said rotator dog and said central gear dog checked by the sensing switches.

According to another aspect of the present invention, there is also provided a digital door lock that includes: a tubular part having a generally cylindrical hole formed therein, having a hall integrated circuit (IC) for sensing a magnetic force and a flexible PCB for driving the hall IC mounted on the front surface of the cylindrical hole, and having a connector for the hall IC extended along the inner periphery of the hole; a dead bolt assembly inserted into the hole of the tubular part such that the hall IC of the tubular part is located on the front portion of the dead bolt assembly; and a strike box to which a dead bolt of the dead bolt assembly is inserted and a magnet providing a magnetic signal to the hall IC is secured.

Preferably, the strike box may further include a groove into which the magnet is inserted at one end of the vertically central shaft thereof.

Also, preferably, the strike box may further include a plate that is disposed on the front surface thereof, for protecting the magnet from the outside.

Preferably, the dead bolt assembly may further include a structure where the hall IC can be inserted.

### BRIEF DESCRIPTION OF THE DRAWINGS

Further objects and advantages of the invention will be more fully understood from the following detailed description taken in conjunction with the accompanying drawings, in which:

FIG. 1 is a perspective view illustrating a digital door lock for sensing the operation state of the door lock itself according to the present invention;

FIG. 2 is a perspective view illustrating the inside body of the digital door lock for sensing the operation state of the door lock itself according to the present invention;

FIG. 3 is a perspective view illustrating the automatic sensing device of FIG. 1; and

FIG. 4 is an exploded perspective view of FIG. 3.

### BEST MODE FOR CARRYING OUT THE INVENTION

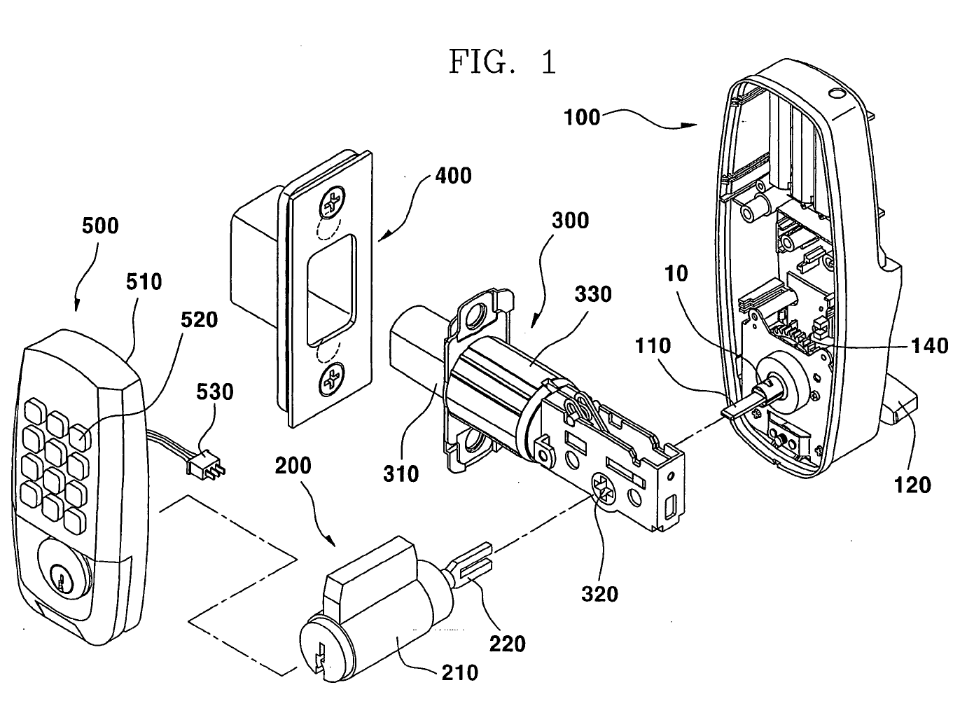

FIG. 1 illustrates a perspective view of a digital door lock for sensing the operation state of the door lock itself according to the present invention.

Referring to FIG. 1, the digital door lock includes an inside body 100 installed on a door facing the indoors, a manual key part 200 installed on the door facing the outdoors, a numeric key input part 500 that is formed integrally with the manual key part 200 and has a plurality of numeric keys arranged thereon in the form of a matrix, and a dead bolt assembly 300 that is adapted to lock and unlock the door. The digital door lock further includes a strike box assembly 400 that is installed on a doorframe to correspond to the dead bolt assembly 300.

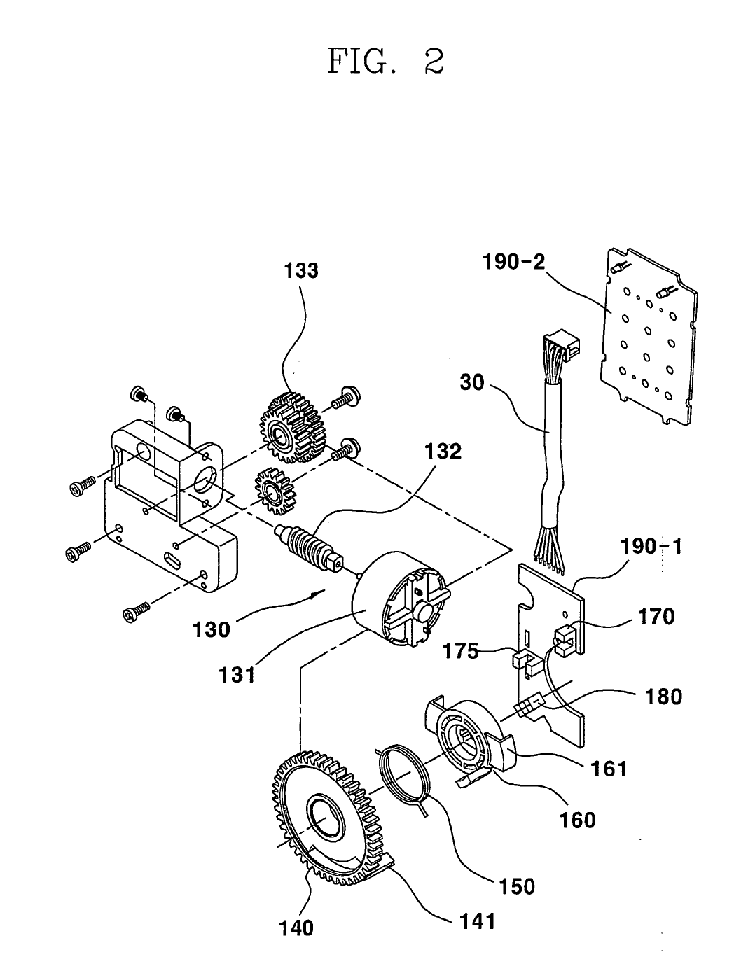

As shown in FIGS. 1 and 2, the inside body 100 includes a tail piece 110 adapted to rotate according to a mechanical movement of a manipulation button and a central gear 140 adapted to make the tail piece 110 rotate by means of an electric motor.

As shown in FIG. 1, the manual key part 200 includes, a key cylinder 210 which is installed on the door facing to the outdoors and is rotated by a key and a key lever 220 that is extended from one end of the key cylinder 210 and rotates as the key cylinder 210 rotates.

The dead bolt assembly 300 includes a cross groove 320 that is adapted to be fitted between the tail piece 110 of the inside body 100 and the key lever 220 of the manual key part 200, a dead bolt 310 that is engaged with or separated from the strike box assembly to lock or unlock the door as the tail piece 110 and the key lever 220 operate, and a tubular part 330 that has a sensor mounted at one end thereof.

The numeric key input part 500 includes a body 510 surrounding the manual key part 200, a numeric key pad 520 with the numeric keys arranged on the front face of the body 510, which is in the form of a matrix, and a signal line 530 for transmitting the signals outputted from the number pad 520 to the outside.

Meanwhile, the strike box assembly 400 includes a strike box 410 into which the dead bolt 310 of the dead bolt assembly 300 is inserted and sensors 411-1 and 411-2 that are mounted on a front plate 430 of the strike box 410, for sensing whether the dead bolt 310 is inserted into the strike box 410.

Now, an explanation of the configuration of the inside body 100 of the digital door lock according to the present invention will be in detail given hereinafter with reference to FIG. 2 which is a perspective view illustrating the inside body of the digital door lock for sensing the operation state of the door lock itself according to the present invention.

The inside body 100 includes: a control part 190-2 to receive the secret number inputted through the numeric key input part 500 by a user; an electric motor assembly 130 to rotate in response to a control signal outputted from the control part 190-2; a central gear 140 to rotate according to the operation of an electric motor 131 included in the electric motor assembly 130; a tension spring 150 to operate according to the rotation of the central gear 140; a rotator 160 to operate when a predetermined force is applied to the tension spring 150; a rotator dog opened state-checking non-contact sensing switch 170 that is formed integrally with the rotator 160, for checking whether a dog 161 of the rotator 160 is opened, in a non-contact sensing manner, a rotator dog closed state-checking non-contact sensing switch 175 to check whether the dog 161 of the rotator 160 is closed, in the non-contact sensing manner; a central gear dog neutral state-checking non-contact sensing switch 180 that is formed integrally with the central gear 140, for checking whether a dog 161 of the central gear 140 operates; and a PBC assembly 190-1 to transmit the signals to the control unit 190-2. Here, the signals are outputted from the rotator dog opened state-checking non-contact sensing switch 170, the rotator dog closed state-checking non-contact sensing switch 175, and the central gear dog neutral state-checking non-contact sensing switch 180.

In this case, the non-contact sensing switches 170, 175 and 180 are implemented by a kind of optical sensor that emits light from one side to the other side and outputs an operation signal in the case that the emitting light is interrupted.

The motor assembly 130 includes the electric motor 131, a driving gear 132 configured in the form of a worm to be coupled to the shaft of the electric motor 131, and a decelerating gear group 133 configured in the form of a worm wheel, for changing the rotational direction of the driving gear 132 and at the same time reducing the rotational speed of the driving gear 132. The decelerating gear 132 is coupled to the central gear 140.

The central gear 140 is formed in such a manner as to be loosely inserted on the lever shaft 10 on which the tail piece 110 is formed along the extended line thereof, SQ that it can be maintained at its static position, irrespective of the rotation of the lever shaft 10.

On the other hand, the lever shaft 10 is provided with a torsion storage spring 150 that stores torsion force in itself generated by the rotating force of the central gear 140, and makes the lever shaft 10 rotate to operate the dead bolt 310 by the torsion force stored.

The torsion force is stored to the torsion storage spring 150 during the rotation of the central gear 140. Here, both ends of the torsion storage spring 150 are locked onto a support projection part (not shown) formed on the one side of the central gear 140 and another support projection part (also not shown) formed on the lever shaft 10, respectively.

The central gear 140 is returned to the central gear dog neutral state-checking non-contact sensing switch 180 to thereby release the torsion stored on the tension spring 150 as the electric motor 131 is driven reversely in response to the signal from the non-contact sensing switch 170 or 175 produced by the forward or backward rotation at an angle of about 90° of the lever shaft 10. That is, the lever shaft 10 starts to rotate as the central gear 140 rotates and if the rotator dog 161 is located at the rotator dog opened state checking non-contact sensing switch 170 or the rotator dog closed state-checking non-contact sensing switch 175, the electric motor 131 is driven reverse, such that the central gear 140 is located at the central gear dog neutral state-checking non-contact sensing switch 180.

Now, the operation and effect of the digital door lock according to the present invention will be explained as below.

The digital door lock according to the present invention can lock and unlock the door automatically and manually.

First, the manual manipulation of the digital door lock is carried out by the following processes. At the indoors, the operation lever 20 of the inside body 100 rotates in the forward or reverse direction at an angle of about 90° and thus, the lever shaft 10 that is coupled to the operation lever starts to operate, such that the dead bolt 310 is extruded or retrieved to allow the door to lock or unlock. To the contrary, at the outdoors, the key cylinder 210 is rotated in the forward or reverse direction at an angle of about 90° by a spare key and thus, the key lever 220 that is coupled to the key cylinder 210 starts to operate, such that the dead bolt 310 is extruded or retrieved to allow the door to lock or unlock.

In the case where the operation lever 120 or the key cylinder 210 is manipulated manually, the central gear 140 is in the neutral state such that the tension spring 150 does not have any torsion force from the central gear 140.

Accordingly, the lever shaft 10 or the key cylinder 210 can rotate smoothly. At this time, upon the manual operation of the lever shaft 10 or the key cylinder 210, the central gear 140 that is fitted around the lever shaft 10 does not rotate but is kept at a stationary state.

On the other hand, the automatic manipulation of the digital door lock is carried out by the following processes. At the indoors, when the secret number is keyed in the state where the dead bolt 310 is extruded, a signal informing this is transmitted to the motor 131 through a microcomputer of the control unit to operate the driving gear 132, such that the driving force is delivered to the central gear 140 through the decelerating gear group 133 that is engaged with the driving gear 132. This enables the central gear 140 to rotate.

At this time, when the signal corresponds to the door closed state, the central gear 140 rotates until the dead bolt 310 is extruded and thereby, the rotator dog 161 is located at the rotator dog closed state-checking non-contact sensing switch 175 that comes in contact with the lever shaft 10 as the lever shaft 10 is rotated in the forward or backward direction at the angle of about 90°, such that the motor 131 operates reversely to permit the rotator dog 160 to return to the central gear dog neutral state-checking non-contact sensing switch 180. This causes the torsion in the tension spring 150 to be released.

When the signal corresponds to the door opened state, the central gear 140 rotates until the dead bolt 310 is returned to its original position and thereby, the rotator dog 161 is located at the rotator dog opened state checking non-contact sensing switch 170 that comes in contact with the lever shaft 10 as the lever shaft 10 rotates in the forward or backward direction at the angle of about 90°, such that the motor 131 operates reversely to permit the rotator dog 160 to return to the central gear dog neutral state-checking non-contact sensing switch 180. This causes the torsion in the tension spring 150 to be released. In other words, the lever shaft 10 rotates as the central gear 140 rotates, and when the rotator dog 161 is located at the rotator dog opened-checking non-contact sensing switch 170 or the rotator dog closed-checking non-contact sensing switch 175, the electric motor 131 operates reversely to permit the rotator dog 160 to be positioned on the central gear dog neutral state-checking non-contact sensing switch 180, which enables the torsion in the tension spring 150 to be released, thereby making the lever shaft 10 smoothly rotate.

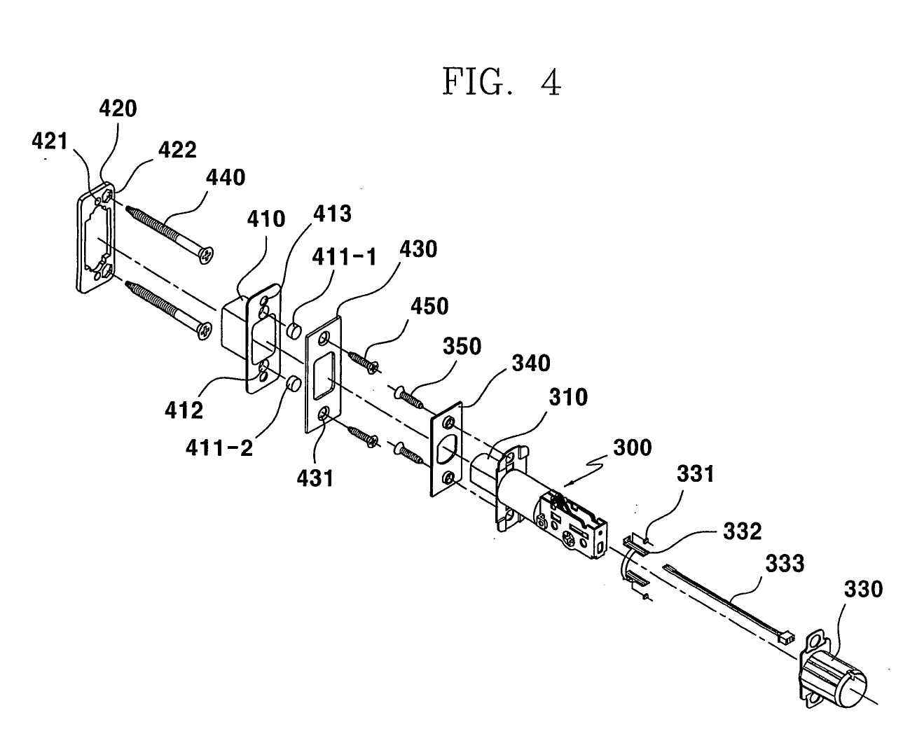

On the other hand, the tubular 330 as shown in FIGS. 1 and 4 is of a generally hollow cylindrical body that is fitted into the dead bolt assembly 300 and has a hall IC 331 for sensing a magnetic force and a flexible PCB 332 for driving the Hall IC 331, on the front surface of the cylindrical body, and a connector 333 of the Hall IC 331 extruded along the inner periphery of the cylindrical body to be connected to the control unit.

Fixing screws 350 are used to fix a plate 340, the dead bolt assembly 300 and the tubular part 330 together, and another fixing screws 450 passes through the holes 431 formed on the front face 430 of the strike box 410, the holes 413 formed on the strike box 410, and the holes 421 formed on a strike reinforce 420, thereby fixing all of them together.

Magnets 411 are inserted into the strike box 410, for transmitting the magnetic force to the Hall IC 331, and a strike box front plate 430 is attached on the front face of the strike box 410, for preventing the magnets 411 from being exposed to the outside.

The dead bolt assembly 300 is provided with a hole 311 into which the Hall IC 331 is inserted, on the panel surface thereof, and with the dead bolt assembly protecting plate 340 on the front of the panel surface thereof.

The magnets 411 inserted into the strike box 410 supply a magnetic signal to the hall IC 331 installed at one end of the dead bolt assembly 300, in which the magnetic signal passes through the strike box front plate 430 and the dead bolt assembly protecting plate 340 and is installed at one end of the dead bolt assembly 300.

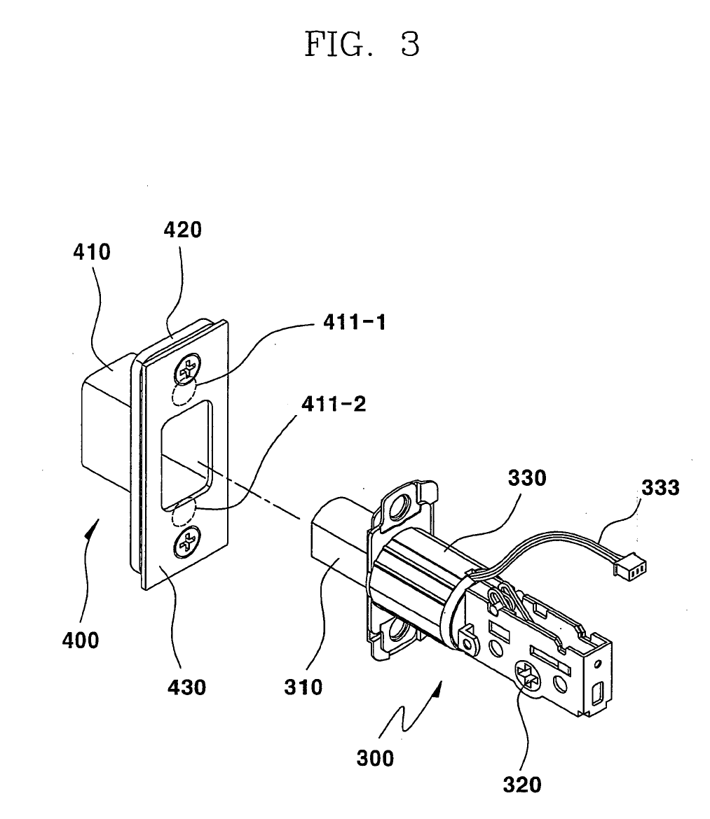

In operation, as shown in FIG. 3 a strike reinforce 420, the strike box 410 and the strike box front plate 430 are attached on the doorframe, and the dead bolt assembly 300, the tubular 330 and the plate 340 are installed on the door side.

Upon the attachment on the doorframe, the strike reinforce 420 is coupled to the doorframe by means of reinforce bolts 440, and mounting screws 450 on the doorframe side are used to couple the strike reinforce 420, the strike box 410 and the strike box front plate 430 with one another, such that they are firmly fixed to the doorframe.

The magnets 411 coupled into the strike box 410 emit the magnetic forces through the strike box plate 430 to the outside.

Meanwhile, the dead bolt assembly 300 is provided with the Hall IC 331 for sensing the magnetic force of the magnets 411, and thus, if the Hall IC 331 senses the magnetic force, it directly outputs a sensed signal to the control unit which in turn outputs a control signal in response to the sensed signal.

The strike box front plate 430 and the plate 340 must be made of a material capable of transmitting the magnetic force, because the hall IC 331 for sensing the magnetic force from the magnets 411 does not directly contact with the magnet 411, but senses the magnetic force through the strike box front plate 430 and the plate 340.

Since the doorframe and the door are separated in case of opening the door, the magnets 411-1 and 411-2 located on the doorframe and the hall IC 331 located on the door are separated, such that the signal from the hall IC 331 is not inputted to the control part. At this time, the control part determines that the door is opened.

After that, since the doorframe and the door are in contact with each other in case of closing the door, the Hall IC 331 is switched by a distribution of the magnetic force from the magnets 411 and outputs a signal showing that the door is in a closed state to the control part.

At this time, the control part checks whether the dead bolt 310 operates in the door open state, and if so, it makes the motor (not shown) operate such that the central gear 140, the key lever 10 and the tail piece 110 all work. Thereby, the cross groove 320 is moved to allow the dead bolt 310 to be extruded from the dead bolt assembly 300, with a result that the door is automatically induced to the door closed state.

Of course, in normal cases the door is always locked when the door is closed, but if desired, a manual switch can be separately installed such that the door is not really locked even though it is closed.

The feature of the digital door lock according to the present invention is to allow the door to be opened or closed with the use of the conventional door locks. That is to say, the present invention is implemented like that a hole into which a magnet is inserted is formed on the conventional strike box, and a tubular part into which a hall IC is inserted is coupled to the conventional dead bolt assembly, such that the open/closed state of the door can be easily sensed.

From the viewpoint of giving more beautiful appearance both on the doorframe and the door, the above-mentioned installation configuration can be more effective than that where additional sensors are installed at another positions of the doorframe and door.

In addition, if the dead bolt is broken to forcibly unlock the door, a contact point between the magnets and the hall IC is released, such that an alarming sound as a warning to an intruder is generated from the control part.

Therefore, the digital door lock according to the present invention is embodied by simply inserting the magnets and the Hall IC into the conventional door lock structure, such that the sensing of a door open/closed state is stably carried out, without any change on the appearances of the door and doorframe.

### INDUSTRIAL APPLICABILITY

As set forth in the foregoing, the digital door lock according to the present invention is capable of sensing an opened/closed state of a door by using the non-contact sensing switches and also recognizing the location of the central gear by using the same sensing switches, thereby increasing accuracy of the sensing and also significantly lengthening a life span of the door lock.

Additionally, the digital door lock according to the present invention has an advantage in that it is combined with the conventional door lock device, such that no additional devices are needed to be installed at the outside and sensing the opened/closed state of the door in the non-contact sensing manner, without having any mechanical motion, thereby improving the reliability and stability of the operation

While the present invention has been described with reference to a few specific embodiments, the description is illustrative of the invention and is not to be construed as limiting the invention. Various modifications may occur to those skilled in the art without departing from the true spirit and scope of the invention as defined by the appended claims.

1. A digital door lock sensing self-operation states, comprising:
a door opened state-determining non-contact sensing switch to determine an opened position of a rotator dog;
a door closed state-determining non-contact sensing switch to determine an closed position of a rotator dog;
a central gear dog neutral state-determining non-contact sensing switch to determine a neutral position of a central gear dog; and
a printed circuit board (PCB) assembly having said door opened state-determining non-contact sensing sensor, said door closed state-determining non-contact sensing sensor and said central gear dog neutral state-determining non-contact sensing sensor mounted on the front thereof, to output the position signals of said rotator dog and said central gear dog determined by the sensing sensors.

2. The digital door lock according to claim 1, wherein said non-contact sensing switches comprise an optical sensor.

3. A digital door lock comprising:
a tubular including:
a cylindrical hole formed therein;
a Hall integrated circuit (IC) formed in the front of the cylindrical hole for sensing a magnetic force;
a flexible PCB for driving said Hall IC; and
a connector for said hall IC extended along the inner periphery of said cylindrical hole;
a dead bolt assembly inserted into the hole of said tubular such that said Hall IC of said tubular is located on the front of said dead bolt assembly; and
a strike box to which a dead bolt of said dead bolt assembly is inserted and a magnet for providing a magnetic signal to said hall IC is secured.

4. The digital door lock according to claim 3, wherein said strike box further comprises a groove into which said magnet is inserted at one end of the vertically central shaft thereof.

5. The digital door lock according to claim 3, wherein said strike box further comprises a plate disposed on the front thereof, for protecting said magnet from the outside.

6. The digital door lock according to claim 3, wherein said dead bolt assembly further comprises a structure where said hall IC can be inserted.
